(19) United States
(12) Patent Application Publication
(10) Pub. No.: US 2016/0210304 A1
(43) Pub. Date: Jul. 21, 2016

(54) COMPUTER-READABLE RECORDING MEDIUM, INFORMATION PROCESSING APPARATUS, AND CONVERSION PROCESS METHOD

(71) Applicant: FUJITSU LIMITED, Kawasaki-shi (JP)

(72) Inventors: Kosuke TAO, Kawasaki (JP); Masahiro KATAOKA, Kamakura (JP); Masao IDEUCHI, Hachioji (JP)

(73) Assignee: FUJITSU LIMITED, Kawasaki-shi (JP)

(21) Appl. No.: 14/995,343

(22) Filed: Jan. 14, 2016

(30) Foreign Application Priority Data
Jan. 19, 2015 (JP) 2015-008103

(51) Int. Cl. G06F 17/30; G06F 17/22

(52) U.S. Cl. CPC G06F 17/30153; G06F 17/2247

(57) ABSTRACT

An information processing apparatus inputs a character data string that includes therein a tag. The information processing apparatus judges whether a target character string includes a tag, the target character string being targeted for a first conversion process using the sliding window and being part of input character string data. If the target character string does not include any tags, the information processing apparatus performs the first conversion process on the target character string and moves the target character string to the sliding window. If the target character string includes the tag, the information processing apparatus performs a second conversion process that is different from the first conversion process.

### CROSS-REFERENCE TO RELATED APPLICATION

This application is based upon and claims the benefit of priority of the prior Japanese Patent Application No. 2015-008103, filed on Jan. 19, 2015, the entire contents of which are incorporated herein by reference.

### FIELD

The embodiment discussed herein is directed to a computer-readable recording medium or the like.

### BACKGROUND

Structured documents, such as XML, HTML, or the like, are described in a text format together with tags and document content (body text). Because these structured documents are described in accordance with structure definition called a schema, unlike general text documents that contain only texts, the degree of freedom of descriptions is low and similar character strings tend to appear. This characteristic is particularly distinguished in tags. An example of the tag in an XML format includes a character string that begins with “<” and that ends with “>”.

Consequently, compression of a structured document is compatible with LZ77 compression, such as ZIP in which codes are allocated by a longest match search, and thus it is possible to obtain a compression ratio higher than that of a general text document.

Patent Document 1: Japanese Laid-open Patent Publication No. 2000-101442

However, in LZ77 compression, in general, it is known that a longest match tends to occur between tags and occur between body texts. Accordingly, in LZ77 compression in which a tag and a body text are collectively sent to a referring unit, because the content of tags subjected to a compression process is sequentially sent to a sliding window, there may be a case in which a longest match character string of a body text is expelled from a sliding window. Namely, because the size of a sliding window is previously set, if an amount of data stored in the sliding window exceeds the size of the sliding window, the data that was stored in the sliding window first is expelled. Accordingly, in LZ77 compression performed in the structured documents, the region of the longest match of the body text becomes narrow. Namely, in LZ77 compression performed in the structured documents, there is a problem in that a compression ratio of a body text is decreased.

In the following, a problem of decreasing a compression ratio of a body text will be described with reference to FIG. 1. FIG. 1 is a schematic diagram illustrating a compression process performed by using an LZ77 type. The upper portion illustrated in FIG. 1 indicates a compression process performed on a text that does not contain therein a tag, whereas, the lower portion illustrated in FIG. 1 indicates a compression process performed on a text that contains therein a tag. As illustrated in FIG. 1, each of a storage area A1 and a storage area A2 are reserved in, for example, a memory. The storage area A1 is referred to as, for example, an encoding unit. The storage area A2 corresponds to a sliding window and is referred to as, for example, a referring unit.

In the compression process, a compression target file, which is not illustrated, is loaded in the storage area A1. Then, the compression process creates a compression code on the basis of a data string (longest match data string) that has a longest match with the data in the storage area A1 from among the pieces of data in the storage area A2. The compression code is information on a combination of the length of the matched longest match data string in the storage area A2 and the position thereof in the storage area A2.

In a case of the text without tag illustrated in the upper portion in FIG. 1, the compression process allocates, from among the character strings included in the storage area A2, “by James Joyce . . . ” that is targeted for the compression process in the storage area A1 and the character string “by James Joyce” that is found as the longest match are allocated to a single code.

In a case of the text that contains therein the tag illustrated in the lower portion in FIG. 1, in the storage area A2, because the content of the tag that has been subjected to the compression process is input to the storage area A2, “by James Joyce” is expelled. The character string that corresponds to the longest match of “by James Joyce . . . ” targeted for the compression process in the storage area A1 has been expelled from the storage area A2. Namely, if a large amount of content of the tag is included in the storage area A2, a body text is promptly expelled from the storage area A2, the region of the longest match of the body text becomes small. Namely, when compared with the text that does not contain therein a tag, a compression ratio of the body text is decreased.

### SUMMARY

According to an aspect of an embodiment, a computer-readable recording medium stores therein a conversion program using a sliding window that causes a computer to execute a process. The process includes judging whether a target character string includes a tag, the target character string being targeted for a first conversion process using the sliding window and being part of input character string data, performing the first conversion process on the target character string and moving the target character string to the sliding window when the target character string does not include any tags, and performing a second conversion process on the tag, when the target character string includes the tag, the second conversion process being different from the first conversion process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic diagram illustrating a compression process performed by using an LZ77 type;

FIG. 2 is a schematic diagram (1) illustrating the flow of a compression process performed by an information processing apparatus according to an embodiment;

FIG. 3 is a schematic diagram illustrating an example of a dynamic dictionary unit;

FIG. 4 is a schematic diagram illustrating an example of compressed data;

FIG. 5 is a schematic diagram (2) illustrating the flow of the compression process performed by the information processing apparatus according to the embodiment;

FIG. 6 is a schematic diagram (3) illustrating the flow of the compression process performed by the information processing apparatus according to the embodiment;

FIG. 7 is a schematic diagram illustrating the flow of a decompression process performed by the information processing apparatus according to the embodiment;

FIG. 8 is a functional block diagram illustrating the configuration of the information processing apparatus according to the embodiment;

FIG. 9 is a functional block diagram illustrating an example of the configuration of a compression unit according to the embodiment;

FIG. 10 is a functional block diagram illustrating an example of the configuration of a decompression unit according to the embodiment;

FIG. 11 is a flowchart illustrating the flow of a process performed by the compression unit according to the embodiment;

FIG. 12 is a flowchart illustrating the flow of a process performed by the decompression unit according to the embodiment;

FIG. 13 is a block diagram illustrating an example of the hardware configuration of a computer;

FIG. 14 is a schematic diagram illustrating a configuration example of a program running on the computer; and

FIG. 15 is a schematic diagram illustrating a configuration example of a device in a system according to the embodiment.

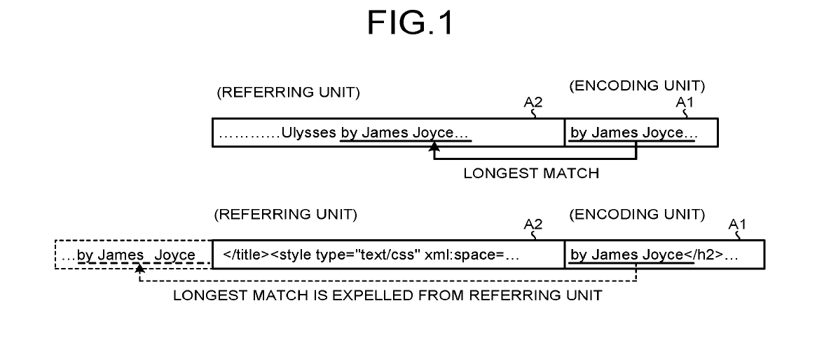

### DESCRIPTION OF EMBODIMENTS

Preferred embodiments of the present invention will be explained with reference to accompanying drawings. The present invention is not limited to the embodiment.

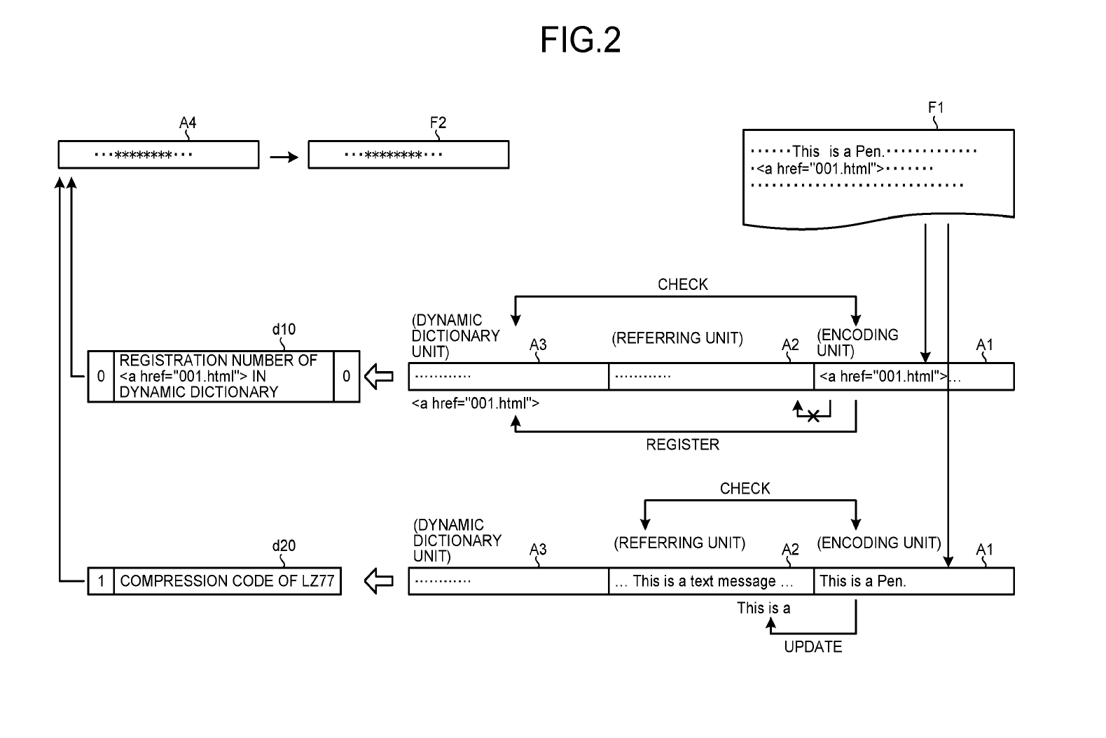

FIG. 2 is a schematic diagram (1) illustrating the flow of a compression process performed by an information processing apparatus according to an embodiment. The information processing apparatus includes a storage area A1, a storage area A2, a storage area A3, and a storage area A4 in a memory as work areas of the compression process. In a description below, the storage area A1, the storage area A2, the storage area A3 are appropriately referred to as an encoding unit, a referring unit, and a dynamic dictionary unit, respectively.

The information processing apparatus loads, into the storage area A1, the character string of the content portion in a file F1 that is targeted for compression. The file F1 is a markup document that contains therein tags and character strings other than the tags in a mixed manner and in which markup specification, such as prescription of the document structure using tags, annotations with respect to a character string, or the like, is performed. The tag mentioned here is a character string that is used for markup specification and is, for example, a character string that begins with a start symbol “<” and ends with an end symbol “>”. For example, the file F1 includes therein the character string of “ . . . This is a Pen. . . . <a href=“001.html”> . . . ”. In this character string, “<a href=“001.html”>” is the tag. In this character string, “This is a Pen.” is a character string other than the tag. The symbol of “ . . . ” is associated with an unspecified character string.

The information processing apparatus extracts a character string from the top in the storage area A1 and determines whether the character string is a tag. For example, the information processing apparatus determines whether the first character of the character string is the start symbol “<” of the tag.

If the character string does not include the tag, the information processing apparatus searches the storage area A2 for a longest match character string with respect to the character string. Furthermore, the information processing apparatus compresses the character string to a compression code associated with the searched longest match character string. Then, the information processing apparatus shifts a sliding window by an amount corresponding to the character string that has been subjected to the compression process. Namely, the information processing apparatus updates the storage area A2 by copying the character string, which has been subjected to the compression process, from the storage area A1 to the storage area A2 and shifting the character string in the storage area A2 to the left by an amount equal to the character string that has been subjected to the compression process.

If the character string includes the tag, the information processing apparatus correctively registers the entirety of the tag in a dynamic dictionary and compresses, on the basis of the dynamic dictionary, the character string to a compression code that is associated with the character string. Furthermore, if the character string is the tag, the information processing apparatus does not shift the sliding window.

The dynamic dictionary mentioned here is a dictionary that is used to register character strings of tags and allocate registration numbers of the character strings registered in the dynamic dictionary to compression codes of the character string. The data structure of the dynamic dictionary will be described later.

A description will be given of a process performed when the information processing apparatus compresses the character string of “This is a Pen. . . . ” in the file F1 targeted for compression.

First, the information processing apparatus determines whether the first character “T” of the character string is the start symbol “<” of the tag. In the example illustrated in FIG. 2, it is determined that the first character “T” of the character string is not the start symbol “<” of the tag. Thus, the information processing apparatus checks the character string in the storage area A2 against “This is a Pen. . . . ” and searches for a longest match character string. In the example illustrated in FIG. 2, because “This is a” is the longest match character string in the storage area A2, on the basis of the position of the longest match character string in the storage area A2 and on the basis of the length of the data on the longest match character string, compressed data d20 including therein compression codes of LZ77 is created. In the compression codes of LZ77, an identifier (“1” that is not illustrated) indicating the compressed data based on the longest match character string is included. Furthermore, in compressed data d20, an identifier (“1” in the example illustrated in FIG. 2) indicating the compressed data of the character string that is not a tag is included.

Then, the information processing apparatus updates the storage area A2 by copying the character string of “This is a”, which has been subjected to the compression process, from the storage area A1 to the storage area A2 and shifting the character string in the storage area A2 to the left by an amount equal to the character string that has been subjected to the compression process.

Furthermore, in the example illustrated in FIG. 2, the compression target of “Pen. . . . ” subsequent to “This is a” is processed as follows. If “Pen. . . . ” is not the longest match character string in the storage area A2, the compressed data d20 of LZ77 that includes therein the first character code itself is created. Using the character code itself as the compressed data is only an example; therefore, a Huffman code obtained from being decoded by using the Huffman encoding/decoding algorithm may also be used or another compression algorithm may also be used. In the compression code of LZ77, an identifier (“0” that is not illustrated) indicating that the character string is not compressed data based on the longest match character string is included. Furthermore, in the compressed data d20, an identifier (in the example illustrated in FIG. 2, “1”) indicating compressed data of the character string that is not a tag is included.

Then, the information processing apparatus updates the storage area A2 by copying the character “P”, which has been subjected to the compression process, from the storage area A1 to the storage area A2 and shifting the character string in the storage area A2 to the left by an amount equal to the character string that has been subjected to the compression process. Because the same process is also performed on the compression target of “en. . . . ” subsequent to “P”, a description thereof will be omitted.

In the following, a description will be given of a process performed when the information processing apparatus compresses the character string “<a href=“001.html”>” in the file F1 that is targeted for compression.

First, the information processing apparatus determines whether the first character of the character string is the start symbol “<” of the tag. In the example illustrated in FIG. 2, it is determined that the first character “<” of the character string is the start symbol “<” of the tag. Thus, the information processing apparatus checks the character string in the storage area A3 against “<a href=“001.html”>” and determines whether both match. In the example illustrated in FIG. 2, because “<a href=“001.html”>” is not present in the storage area A3, the information processing apparatus registers the character string of the tag in the dynamic dictionary by associating the character string with a new registration number. Namely, the information processing apparatus collectively associates “<a href=“001.html”>” with the new registration number and registers the information in the dynamic dictionary.

Furthermore, the information processing apparatus creates the compressed data d10 in which the registration number registered in the dynamic dictionary is used as a compression code. In the compressed data d10, the identifier (“0” in the example illustrated in FIG. 2) indicating the compressed data of the character string corresponding to the tag is included. Furthermore, in the compressed data d10, an identifier (“0” in the example illustrated in FIG. 2) indicating whether variable part information is present in the compressed data is included in the last string. This identifier (referred to as a “variable part identifier”) will be described later. Furthermore, because the character string is a tag, the information processing apparatus does not copy the character string of the tag, which has been subjected to the compression process, from the storage area A1 to the storage area A2 and does not update the storage area A2. Thus, by compressing the character string that is a tag by using a process that is different from the process used for the character string that is not a tag, the information processing apparatus does not expel a character string that may possibly be a longest match character string and that is not a tag from the storage area A2 by a tag, whereby it is possible to improve a compression ratio of the character string that is not a tag.

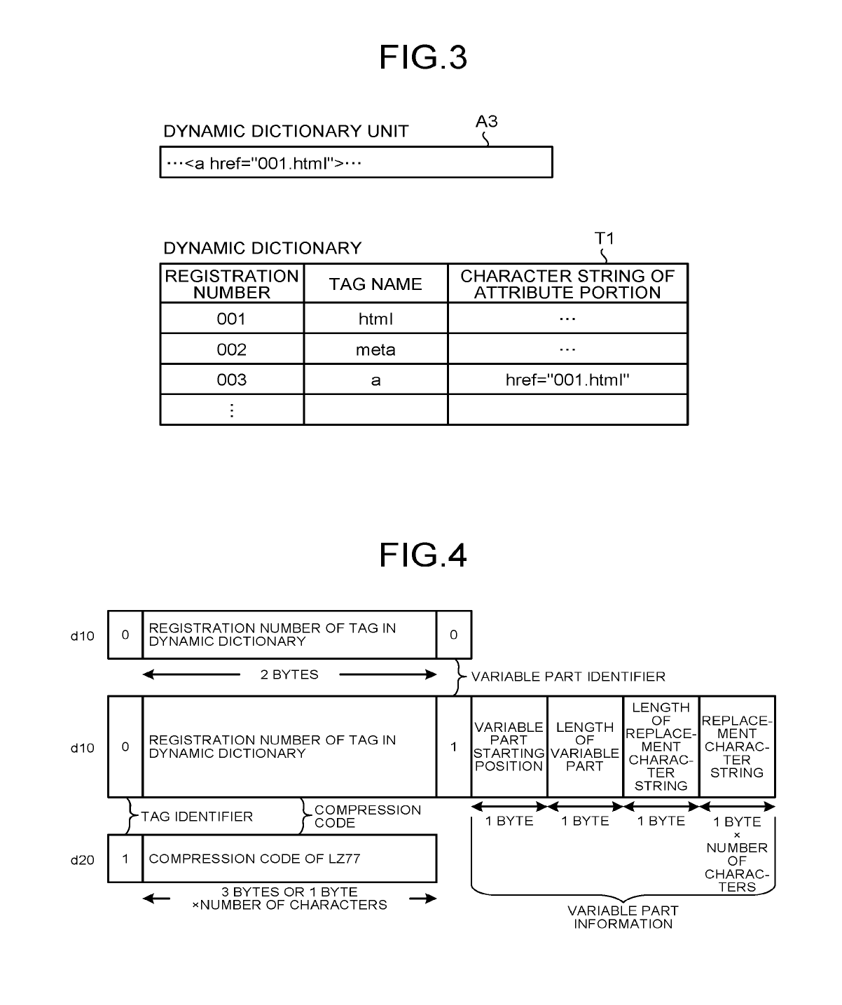

FIG. 3 is a schematic diagram illustrating an example of a dynamic dictionary unit. The dynamic dictionary unit illustrated in FIG. 3 includes the storage area A3 and a dynamic dictionary T1. The storage area A3 stores therein a character string of a tag. The dynamic dictionary T1 is included in the storage area A3 and stores therein, in an associated manner, a registration number, a tag name, and a character string of an attribute portion. The registration number is information indicating the order of registration of, for example, a character string of a tag registered in the storage area A3.

The tag name is information indicating the name of a tag. The character string of an attribute portion is information described subsequent to the tag name in the tag. Namely, in the dynamic dictionary T1, tags with different tag names are registered with new registration numbers and tags with the same tag name are registered, in principle, with the same registration number. However, there may be a case in which, even if tags have the same tag name, the content of parts of a character string of the attribute portion do not match. Even in this case, because the tag names are the same, the tags are registered with the same registration number. However, the information on the content of mismatched portion is added to the compressed data as variable part information, which will be described later.

For example, a case in which “<a href=“001.html”>” indicating a tag is registered in the dynamic dictionary unit A3 will be described. In “<a href=“001.html”>”, “a” is the information indicating the tag name. In “<a href=“001.html”>”, “href=“001.html”” is the information indicating the character string of the attribute portion. The information processing apparatus registers, in the dynamic dictionary T1, “003” as the registration number, “a” as the tag name, “href=“001.html”” as the character string of the attribute portion.

FIG. 4 is a schematic diagram illustrating an example of compressed data. As illustrated in FIG. 4, in the compressed data, a tag identifier, a compression code, a variable part identifier, and variable part information are included. The tag identifier is information for identifying whether compressed data is a tag. As an example, “0” indicates that the character string is compressed data of a character string that is a tag, whereas, “1” indicates that the character string is compressed data of a character string that is not a tag. The compression code is information indicating compression code in accordance with a tag identifier. As an example, if the tag identifier is “0”, in the compression code, information indicating the registration number of a tag registered in the dynamic dictionary is set. The size of the compression code is, for example, 2 bytes that is a fixed length. If the tag identifier is “1”, a compression code of LZ77 is set in the compression code. The size of the compression code is, if a character string is a longest match character string, 3 bytes that is a fixed length including the position and the length of data and is, if a string is not the longest match character string, the number of bytes obtained by multiplying 1 byte of the fixed length by the number of characters.

The variable part identifier is information indicating an identifier whether variable part information is present in compressed data. As an example, “0” indicates that variable part information is not present in the compressed data, whereas “1” indicates that variable part information is present in the compressed data. The variable part information is information that indicates the content of a mismatched portion in a character string of an attribute portion that is associated with the registration number registered in the dynamic dictionary. In the variable part information, the variable part starting position, the length of a variable part, the length of a replacement character string, and a replacement character string are included. The variable part starting position is information indicating the starting position of a mismatched portion (variable part) in a character string of the attribute portion that is associated with the registration number indicated in the compression code. The size of the variable part starting position is, for example, 1 byte that is a fixed length. The length of the variable part is information indicating the length of a mismatched portion from the variable part starting position. The size of the length of the variable part is, for example, 1 byte that is a fixed length. The length of a replacement character string is information that indicates the length of the character string (replacement character string) replaced with the variable part. The size of the length of the replacement character string is, for example, 1 byte that is a fixed length. The replacement character string is information that indicates a character string replaced with the variable part. The size of the replacement character string is the number of bytes obtained by multiplying, for example, 1 byte that is a fixed length by the number of the replacement character. By providing the variable part information in compressed data, if tag names are the same, the information processing apparatus can set the same registration number in the compression code and add a difference in the character string of the attribute portion as the variable part information, whereby a compression ratio can be improved.

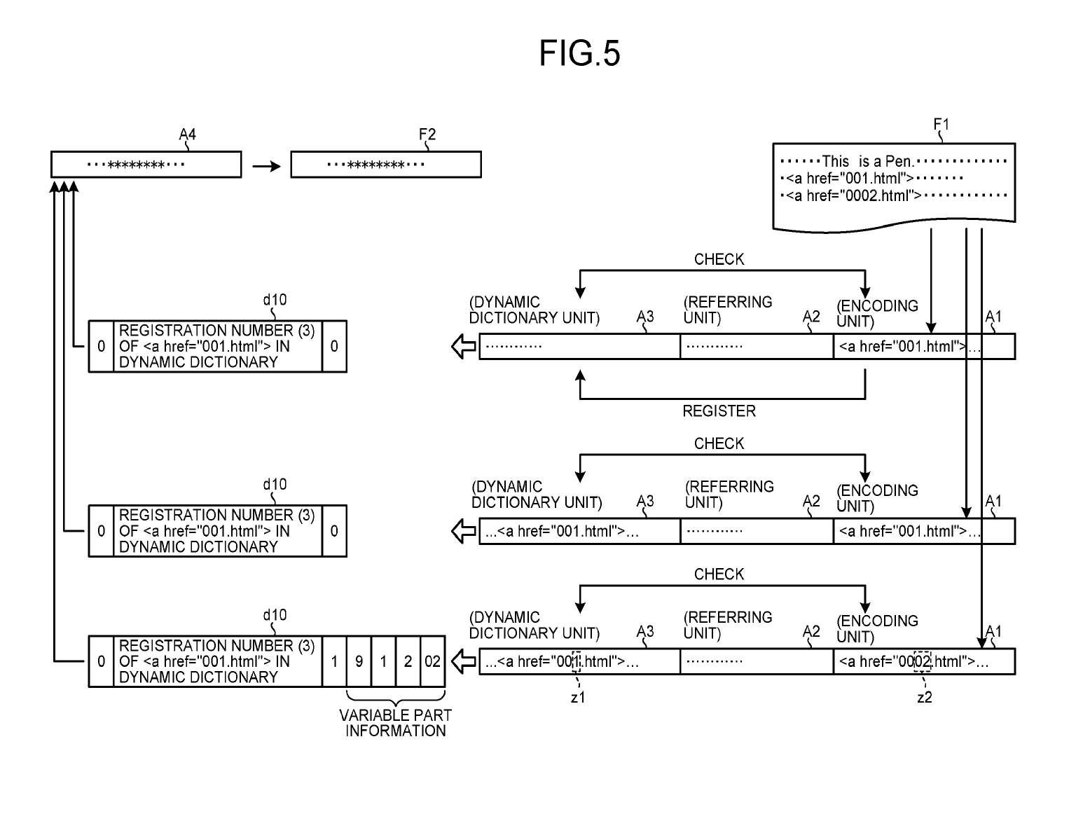

FIG. 5 is a schematic diagram (2) illustrating the flow of the compression process performed by the information processing apparatus according to the embodiment. The information processing apparatus loads, into the storage area A1, the character string of the content portion in the file F1 targeted for compression. For example, in the file F1, the character string of “ . . . This is a Pen. . . . <a href=“001.html”> . . . ” is included. Furthermore, in the storage area A3, the dynamic dictionary T1 is stored.

The information processing apparatus extracts a character string from the top in the storage area A1 and determines whether the character string is a tag. If the character string does not include a tag, the process performed by the information processing apparatus is the same as that illustrated in FIG. 2; therefore, a description thereof will be omitted.

A description will be given of a process performed by the information processing apparatus if a character string includes a tag. First, a description will be given of a process performed when the information processing apparatus creates compressed data of the character string “<a href=“001.html”>”.

Because the first character of the character string “<a href=“001.html”>” is the start symbol “<” of a tag, the information processing apparatus determines that the character string is a tag and then performs the following process. The information processing apparatus checks the tag character string “<a href=“001.html”>” against the storage area A3 and determines whether the tag name included in the tag character string is registered in the dynamic dictionary T1.

For example, as indicated in a first column illustrated in FIG. 5, if the tag name “a” is not stored in the dynamic dictionary T1, the information processing apparatus registers the content of the tag character string “<a href=“001.html”>” in the dynamic dictionary T1. The dynamic dictionary T1 stores therein “a” as the tag name, “href=“001.html”” as the character string of the attribute portion, “3” as the registration number. Then, the information processing apparatus encodes the tag character string “<a href=“001.html”>” by using the dynamic dictionary T1. Namely, the information processing apparatus creates the compressed data d10 by performing compression coding the tag character string to the registration number “3” registered in the dynamic dictionary T1. The information processing apparatus writes the compressed data d10 to the storage area A4. The compressed data d10 includes therein “0” indicating, as a tag identifier, compressed data of a tag character string; “3” indicating, as a compression code, a registration number; and “0” indicating, as a variable part identifier, that variable part information is not present in the compressed data.

For example, as indicated in a second and a third columns illustrated in FIG. 5, if the tag name “a” is stored in the dynamic dictionary T1, the information processing apparatus determines whether the character strings of the attribute portions in both the tag character string and the dynamic dictionary T1 exactly match. It is assumed that the dynamic dictionary T1 stores therein “a” as the tag name, “href=“001.html” as the character string of the attribute portion, and “3” as the registration number.

As indicated in the second column illustrated in FIG. 5, it is assumed that the tag character string in the storage area A1 is “<a href=“001.html”>”. If the character strings of the attribute portions in both the tag character string and the dynamic dictionary T1 exactly match, the information processing apparatus encodes the tag character string by using the dynamic dictionary T1. Namely, the information processing apparatus creates the compressed data d10 by performing compression coding on the tag character string to the registration number “3” that has already been registered in the dynamic dictionary T1. The information processing apparatus writes the compressed data d10 to the storage area A4. The compressed data d10 includes therein “0” indicating, as a tag identifier, compressed data of a tag character string; “3” indicating, as compression code, a registration number; and “0” indicating, as a variable part identifier, that variable part information is not present in the compressed data.

As indicated in the third column illustrated in FIG. 5, it is assumed that the tag character string in the storage area A1 is “<a href=“0002.html”>”. If the character strings of the attribute portions in both the tag character string and the dynamic dictionary T1 do not exactly match, the information processing apparatus determines whether the middle portions of the character strings of the attribute portions are mismatched. The mismatch of the middle portions of the character strings of the attribute portions is determined by, for example, a forward match and a backward match. In the example illustrated in the third column in FIG. 5, the portion of “1” indicated by a code z1 and the portion of “02” indicated by a code z2 are mismatched. If the middle portions of the character strings of the attribute portions are mismatched, the information processing apparatus encodes the tag character string by using the dynamic dictionary T1. Namely, the information processing apparatus creates the compressed data d10 by adding the variable part information to the end of the registration number “3” registered in the dynamic dictionary T1. The information processing apparatus writes the compressed data d10 to the storage area A4. The compressed data d10 includes therein “0” indicating, as a tag identifier, compressed data of a tag character string; “3” indicating, as a compression code, a registration number; and “1” indicating, as a variable part identifier, that variable part information is present in the compressed data. Furthermore, the compressed data d10 includes therein “9” indicating the variable part starting position, “1” indicating the length of a variable part, “2” indicating the length of a replacement character string, and variable part information that includes therein “02” indicating a replacement character string.

The information processing apparatus stores, in the compressed file F2, the compressed data that is stored in the storage area A4.

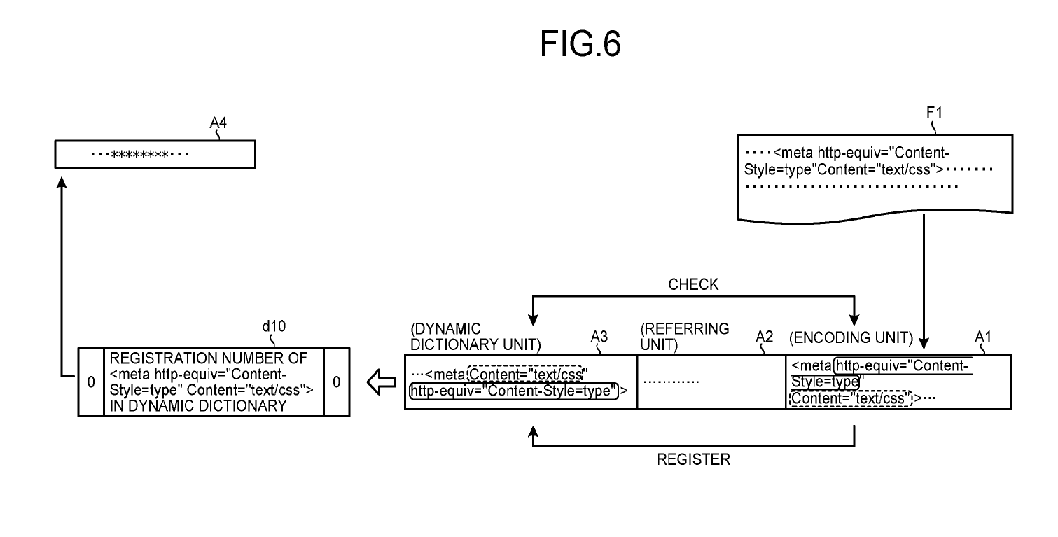

In the following, a description will be given of, with reference to FIG. 6, encoding performed when character strings of the attribute portions are mismatched but the character strings of the middle portions are not mismatched. FIG. 6 is a schematic diagram (3) illustrating the flow of the compression process performed by the information processing apparatus according to the embodiment. It is assumed that, as a case in which the middle portions of the character strings of the attribute portions are not mismatched, the order of the attributes is replaced. It is assumed that the dynamic dictionary T1 stores therein “meta” as the tag name, “Content=“text/css” http-eguiv=“Content-Style=type”” as the character string of the attribute portion, and “4” as the registration number.

It is assumed that the tag character string in the storage area A1 is “<meta http-eguiv=“Content-Style=type” Content=“text/css”>”. Namely, a case in which the order of the attribute of the character string of the attribute portion associated with the tag name “meta” in the dynamic dictionary T1 is replaced. Under this state, because the tag name “meta” is stored in the dynamic dictionary T1, the information processing apparatus determines whether the character strings of the attribute portions of both the tag character strings and the dynamic dictionary T1 exactly match. Because the character strings of the attribute portions of both the tag character strings and the dynamic dictionary T1 do not exactly match, the information processing apparatus determines whether the middle portions of the character strings of the attribute portions are mismatched.

A mismatch of the middle portions of the character strings of the attribute portions is determined by, for example, a forward match and a backward match. In the example illustrated in FIG. 6, because the attributes in the character string of the attribute portion are replaced, the forward match nor the backward match are not found and, furthermore, the middle portions of the character strings of the attribute portions are not mismatched. Thus, the information processing apparatus newly registers, in the dynamic dictionary T10, the content of the tag character string of “<meta http-eguiv=“Content-Style=type” Content=“text/css”>”. The dynamic dictionary T1 stores therein “meta” as the tag name, “http-equiv=“Content-Style=type” Content=“text/css”” as the character string of the attribute portion, and “5” as a new registration number. Then, the information processing apparatus encodes the tag character string by using the dynamic dictionary T1. Namely, the information processing apparatus creates the compressed data d10 by performing the compression coding on the tag character string to the registration number “5” that is registered in the dynamic dictionary T1. The information processing apparatus writes the compressed data d10 to the storage area A4. The compressed data d10 includes therein “0” indicating, as a tag identifier, compressed data of a tag character string; “5” indicating, as a compression code, the registration number; and “0” indicating, as a variable part identifier, that variable part information is not present in the compressed data.

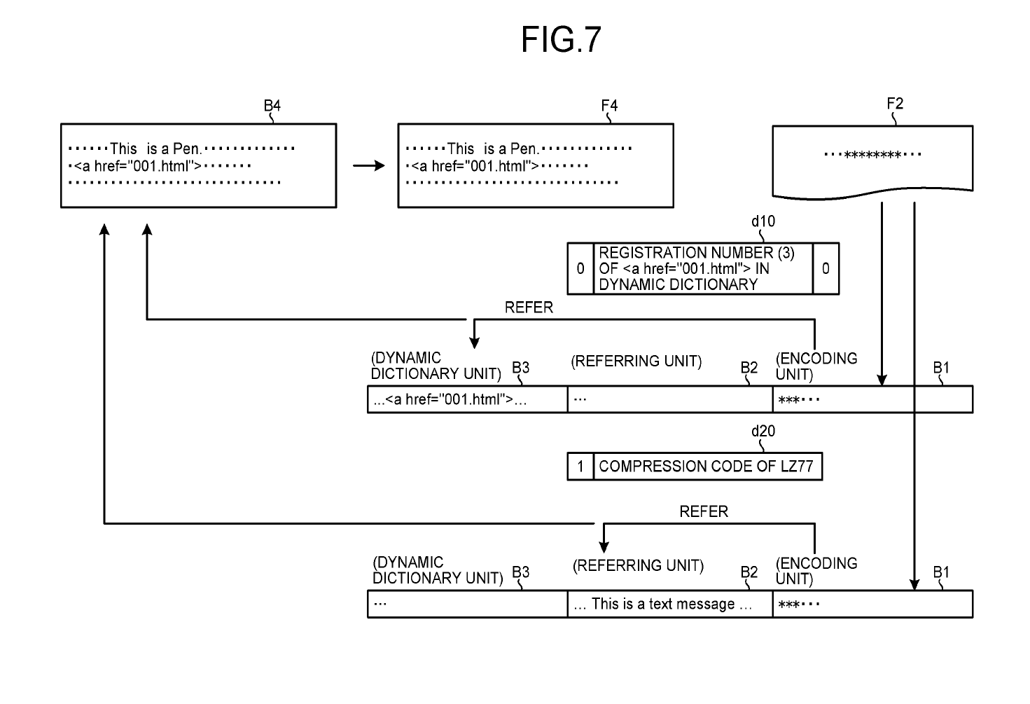

FIG. 7 is a schematic diagram illustrating the flow of a decompression process performed by the information processing apparatus according to the embodiment. The information processing apparatus provides, in the memory, a storage area B1, a storage area B2, and a storage area B3 as a work area of a decompression process. The information processing apparatus loads the compressed file F2 into the storage area B1 and sequentially read the compressed data. The information processing apparatus creates the decompression data on the basis of the read compressed data.

The information processing apparatus performs a decompression process in accordance with the tag identifier included in the compressed data. The information processing apparatus stores the created decompression data in the storage area B4 and a decompressed file F4 is created on the basis of the decompression data stored in the storage area B4. In a description below, the storage area B1 is appropriately referred to as an encoding unit, the storage area B2 is appropriately referred to as a referring unit, and the storage area B3 is appropriately referred to as a dynamic dictionary unit. A decompression process performed on the compressed data d10 and d20 illustrated in FIG. 2 will be described. It is assumed that, for the tag character string “<a href=“001.html”>”, the registration number stored in the dynamic dictionary T1 is “3”.

The information processing apparatus reads the compressed data d10 and checks the tag identifier of the compressed data d10.

If the tag identifier of the compressed data d10 is “0”, the information processing apparatus determines that the compressed data d10 is obtained by encoding the tag. The information processing apparatus refers to the storage area B3 on the basis of the compression code and the variable part identifier in the compressed data d10 and creates decompression data.

For example, if the variable part identifier is “0”, the information processing apparatus determines that the variable part information is not present in the compressed data d10. Then, the information processing apparatus compares the registration number included in the compressed data d10 with the dynamic dictionary T1 in the storage area B3 and specifies the character strings of the tag name and the attribute portion. Then, the information processing apparatus concatenates the character strings of the tag name and the attribute portion and creates decompression data. In this case, because the registration number “3” in the compressed data d10 indicates the tag name “a” and the character string “href=“001.html”” of the attribute portion in the dynamic dictionary T1, the character string of “<a href=“001.html”>” is created as the decompression data.

Furthermore, if the variable part identifier is “1”, the information processing apparatus determines that the variable part information is present in the compressed data d10 and performs the process as follows. The information processing apparatus compares the registration number included in the compressed data d10 with the dynamic dictionary T1 in the storage area B3 and specifies the tag name and the character string of the attribute portion. Then, the information processing apparatus creates decompression data that is obtained by converting the character strings of the tag name and the attribute portion by using the variable part information included in the compressed data d10. As an example, it is assumed that the variable part information is “9” indicating the variable part starting position, “1” indicating the length of the variable part, “2” indicating the length of the replacement character string, and “02” indicating the replacement character string. Then, the character string of “<a href=“0002.html”>” is created as the decompression data.

Furthermore, the information processing apparatus writes the decompression data to the storage area B4.

If the tag identifier of the compressed data d20 is “1”, the information processing apparatus determines that the compressed data d20 is obtained by encoding the character string that is not a tag. The information processing apparatus refers to the storage area B2 on the basis of the compression code in the compressed data d20 and creates decompression data.

For example, if the compression code of LZ77 included in the compressed data d20 includes the identifier (“1” that is not illustrated) indicating the compressed data based on the longest match character string, the information processing apparatus performs the following process. The information processing apparatus specifies the position and the data length of the longest match character string that are included in the compression code of LZ77 and that are in the storage area B2. The information processing apparatus reads the character string associated with the position and the data length of the longest match character string in the storage area B2 and sets the read character string as the decompression data. As an example, the character string of “This is a” is created as the decompression data.

Furthermore, if the compression code of LZ77 included in the compressed data d20 includes the identifier (“0” that is not illustrated) indicating that the data is not the compressed data based on the longest match character string, the information processing apparatus performs the following process. The information processing apparatus sets the character code included in the compression code of LZ77 as the decompression data. As an example, “P” is created as the decompression data. Furthermore, “e” and “n” are created as the decompression data by the compressed data d20, which will be described later.

Furthermore, the information processing apparatus writes the decompression data to the storage area B4.

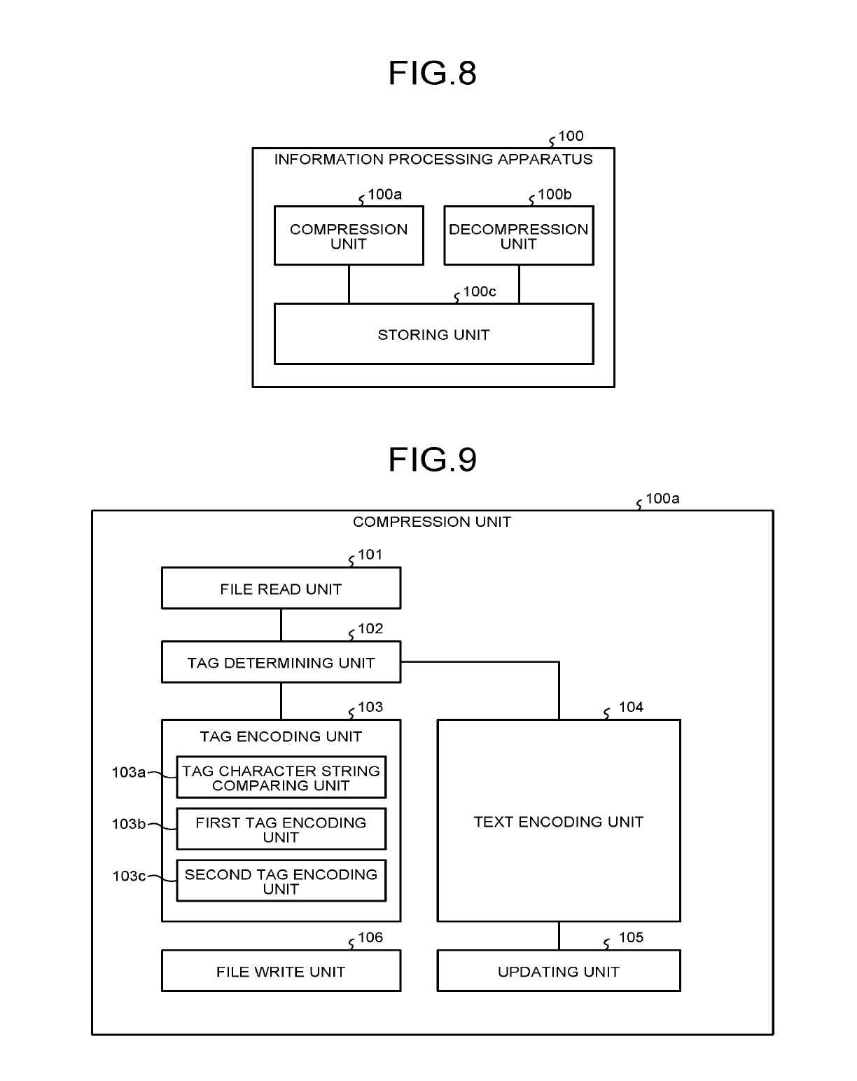

FIG. 8 is a functional block diagram illustrating the configuration of the information processing apparatus according to the embodiment. As illustrated in FIG. 8, an information processing apparatus 100 includes a compression unit 100a, a decompression unit 100b, and a storing unit 100c.

The compression unit 100a is the processing unit that performs the compression process illustrated in FIG. 2, FIG. 5, and FIG. 6. The decompression unit 100b is the processing unit that performs the decompression process illustrated in FIG. 7. The information processing apparatus 100 sets, in the storing unit 100c, the storage areas A1 to A4 and B1 to B4 illustrated in FIG. 2, FIG. 5, FIG. 6, and the like.

FIG. 9 is a functional block diagram illustrating an example of the configuration of a compression unit according to the embodiment. As illustrated in FIG. 9, the compression unit 100a includes a file read unit 101, a tag determining unit 102, a tag encoding unit 103, a text encoding unit 104, an updating unit 105, and a file write unit 106. The tag determining unit 102 is an example of a determining unit. The tag encoding unit 103 is an example of a second conversion processing unit. The text encoding unit 104 is an example of a first conversion processing unit.

The file read unit 101 reads the character string of the content portion in the file F1 to the storage area A1. The file read unit 101 extracts the character string that is read to the storage area A1 and outputs the extracted character string to the tag determining unit 102.

The tag determining unit 102 determines whether the character string is a tag. For example, the tag determining unit 102 determines whether the first character of the character string is the start symbol “<” of the tag. If the first character of the character string is the start symbol “<” of the tag, the tag determining unit 102 outputs the tag character string to the tag encoding unit 103. The tag character string is a character string that begins with the start symbol “<” and that ends with the end symbol “>”. Furthermore, if the first character of the character string is not the start symbol “<” of the tag, the tag determining unit 102 outputs the character string to the text encoding unit 104.

The tag encoding unit 103 encodes the tag character string. The tag encoding unit 103 includes a tag character string comparing unit 103a, a first tag encoding unit 103b, and a second tag encoding unit 103c.

The tag character string comparing unit 103a checks the tag character string with the dynamic dictionary T1 in the storage area A3 and determines whether the tag name included in the tag character string is included in the dynamic dictionary T1. If the tag name included in the tag character string is not registered in the dynamic dictionary T1, the tag character string comparing unit 103a outputs the tag character string to the first tag encoding unit 103b. If the tag name included in the tag character string is registered in the dynamic dictionary T1, the tag character string comparing unit 103a outputs the tag character string to the second tag encoding unit 103c.

The first tag encoding unit 103b registers the content of the tag character string in the dynamic dictionary T1 and creates compressed data in which the newly registered registration number is set to the compression code. As an example, in the dynamic dictionary T1, a new registration number is registered as the registration number, the tag name included in the tag character string is registered as tag name, and the character string of the attribute portion included in the tag character string is registered as the character string of the attribute portion. In the compressed data, “0” is set as the tag identifier, the registration number that is newly registered as the compression code is set, and “0” is set as the variable part identifier.

Furthermore, the first tag encoding unit 103b outputs the compressed data to the file write unit 106.

The second tag encoding unit 103c determines whether the character string of the attribute portion in the tag character string and the character string of the attribute portion in the dynamic dictionary T1 exactly match. If both exactly match, the second tag encoding unit 103c creates compressed data in which the registration number associated with the same tag name as the tag character string is allocated to the compression code. As an example, in the compressed data, “0” is set as the tag identifier, a subject registration number is set as the compression code, and “0” is set as the variable part identifier.

Furthermore, if both do not exactly match, the second tag encoding unit 103c determines whether the middle portions of the character string of the attribute portion in the tag character string are mismatched. For example, the second tag encoding unit 103c performs a prefix search on the character string of the attribute portion in the dynamic dictionary T1 and the character string of the attribute portion in the tag character string. The second tag encoding unit 103c performs a suffix search on the character string of the attribute portion in the dynamic dictionary T1 and the character string of the attribute portion in the tag character string. If a forward match character string or a backward match character string is present, the second tag encoding unit 103c determines that the middle portion of the character string of the attribute portion in the tag character string is mismatched. If one of the character string of the forward match and the character string of the backward match is not present, the second tag encoding unit 103c determines that the middle portion of the character string of the attribute portion in the tag character string is not mismatched.

Furthermore, if the middle portion of the character string of the attribute portion in the tag character string is mismatched, the second tag encoding unit 103c creates the compressed data in which the registration number associated with the same tag name as the tag character string is used as the compression code. In addition, the second tag encoding unit 103c adds, as the variable part information, the information on the mismatched portion to the end of the registration number. As an example, in the compressed data, “0” is set as the tag identifier, a subject registration number is set as the compression code, and “1” is set as the variable part identifier. Furthermore, in the compressed data, variable part information including the variable part starting position, the length of the variable part, the length of the replacement character string, and replacement character string is added.

Furthermore, if the middle portion of the character string of the attribute portion in the tag character string is not mismatched, the second tag encoding unit 103c outputs the tag character string to the first tag encoding unit 103b. This is because the content of the tag character string is newly registered in the dynamic dictionary T1.

Furthermore, the second tag encoding unit 103c outputs the compressed data to the file write unit 106.

The text encoding unit 104 encodes the character string (text) other than a tag. The text encoding unit 104 determines whether the character string matches the character string in the referring unit as the longest match. If the character string matches the character string in the referring unit as the longest match, the text encoding unit 104 creates compressed data that includes therein compression code of LZ77 on the basis of the position and the data length of the longest match character string in the storage area A2. As an example, “1” is set to the compressed data as a tag identifier. The identifier (for example, “1”) indicating the compressed data based on the longest match character string is set as a compression code and the position and the data length of the longest match character string in the storage area A2 are set.

Furthermore, if character string does not match the character string in the storage area A2 as the longest match, the text encoding unit 104 creates compressed data that includes therein a compression code of LZ77 including the first character code itself. As an example, “1” is set to the compressed data as the tag identifier. As the compression code, identifier (for example, “0”) indicating that the data is not compressed data based on the longest match character string and a character code are set.

Furthermore, the text encoding unit 104 outputs the compressed data to the file write unit 106.

After the encoding of the character strings other than the tag has been completed by the text encoding unit 104, the updating unit 105 shifts the sliding window by an amount equal to the encoded character string. Namely, the updating unit 105 stores, in the storage area A2, the encoded character string in the storage area A1 and updates the storage area A2 by shifting the character string in the storage area A2 to the left by an amount equal to the encoded character string. The updating unit 105 shifts the sliding window every time the encoding of the character string other than the tag is completed by the text encoding unit 104. Furthermore, the updating unit 105 does not shift the sliding window after the encoding of the tag has been completed by the tag encoding unit 103. Consequently, because the character string of the tag does not move to the storage area A2, the longest match character string of the character string other than the tag is hardly expelled from the storage area A2, whereby a compression ratio of the character string other than the tag is improved. Namely, because the character string other than the tag is not encoded for each character, the compression ratio is improved.

The file write unit 106 acquires the compressed data from the tag encoding unit 103 and the text encoding unit 104 and writes the acquired compressed data to the storage area A4. The file write unit 106 stores, in the compressed file F2, the compressed data stored in the storage area A4 and the dynamic dictionary T1.

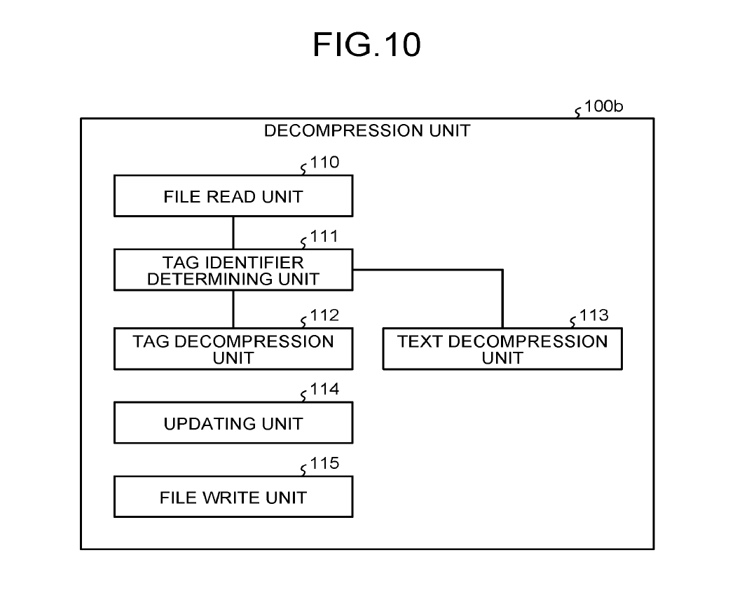

FIG. 10 is a functional block diagram illustrating an example of the configuration of a decompression unit according to the embodiment. As illustrated in FIG. 10, the decompression unit 100b includes a file read unit 110, a tag identifier determining unit 111, a tag decompression unit 112, a text decompression unit 113, an updating unit 114, and a file write unit 115.

The file read unit 110 reads the compressed data in the compressed file F2 to the storage area B1. If the file read unit 110 ends the process performed on the compressed data stored in the storage area B1, the file read unit 110 reads new compressed data from the compressed file F2 and updates the compressed data stored in the storage area B1.

The tag identifier determining unit 111 reads the tag identifier of the compressed data stored in the storage area B1 and determines whether the tag identifier is “0” or “1”. The tag identifier is associated with the first bit of the compressed data. If the tag identifier is “0”, this indicates that the compressed data is obtained by encoding a tag character string. If the tag identifier is “1”, this indicates that the compressed data is obtained by encoding the character string (text) other than a tag. If the tag identifier of the compressed data is “0”, the tag identifier determining unit 111 outputs the compressed data to the tag decompression unit 112. If the tag identifier of the compressed data is “1”, the tag identifier determining unit 111 outputs the compressed data to the text decompression unit 113.

On the basis of the compression code and the variable part identifier in the compressed data, the tag decompression unit 112 refers to the storage area B3 and creates decompression data. If the variable part identifier is “0”, this indicates that variable part information is not present in the compressed data. If the variable part identifier is “1”, this indicates that variable part information is present in the compressed data.

For example, if the variable part identifier is “0”, the tag decompression unit 112 compares the registration number included in the compressed data with the dynamic dictionary T1 in the storage area B3 and specifies the character string of the tag name and the attribute portion associated with the registration number. The tag decompression unit 112 concatenates the character string of the tag name and the attribute portion and creates decompression data.

Furthermore, if the variable part identifier is “1”, the tag decompression unit 112 compares the registration number included in the compressed data with the dynamic dictionary T1 in the storage area B3 and specifies the character string of the tag name and the attribute portion associated with the registration number. In addition, the tag decompression unit 112 converts the character string of the attribute portion by using the variable part information. The tag decompression unit 112 concatenates the tag name and the converted character string and creates decompression data.

Furthermore, the tag decompression unit 112 outputs the created decompression data to the file write unit 115.

The text decompression unit 113 refers to the storage area B2 on the basis of the compression code of LZ77 in the compressed data and creates decompression data.

For example, if the compression code includes the identifier (for example, “1”) indicating that the data is the compressed data based on the longest match character string, the text decompression unit 113 specifies the position and the data length of the longest match character string included in the compression code. The text decompression unit 113 reads the character string associated with the position and the data length from the storage area B2 and creates the read character string as decompression data.

Furthermore, if the compression code includes the identifier (for example, “0”) indicating that the compressed data is not based on the longest match character string, the text decompression unit 113 creates the character code included in the compression code as decompression data.

Furthermore, the text decompression unit 113 outputs the created decompression data to the file write unit 115.

The updating unit 114 deletes the compressed data decompressed by the tag decompression unit 112 from the storage area B1. The updating unit 114 deletes the compressed data that has been decompressed by the text decompression unit 113 from the storage area B1; shifts the storage area B2 to the left by an amount equal to the character string of the decompression data; and writes the decompression data to the storage area B2.

The file write unit 115 acquires the decompression data from the tag decompression unit 112 and the text decompression unit 113 and writes the acquired decompression data to the storage area B4.

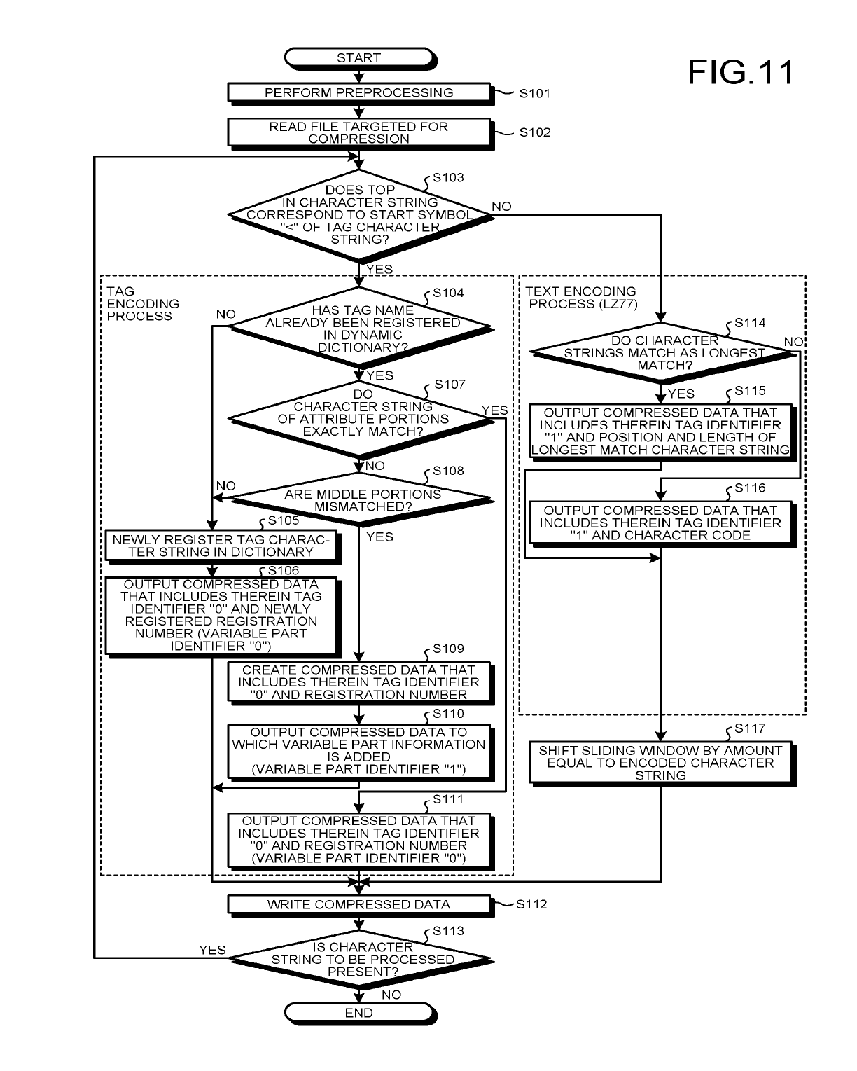

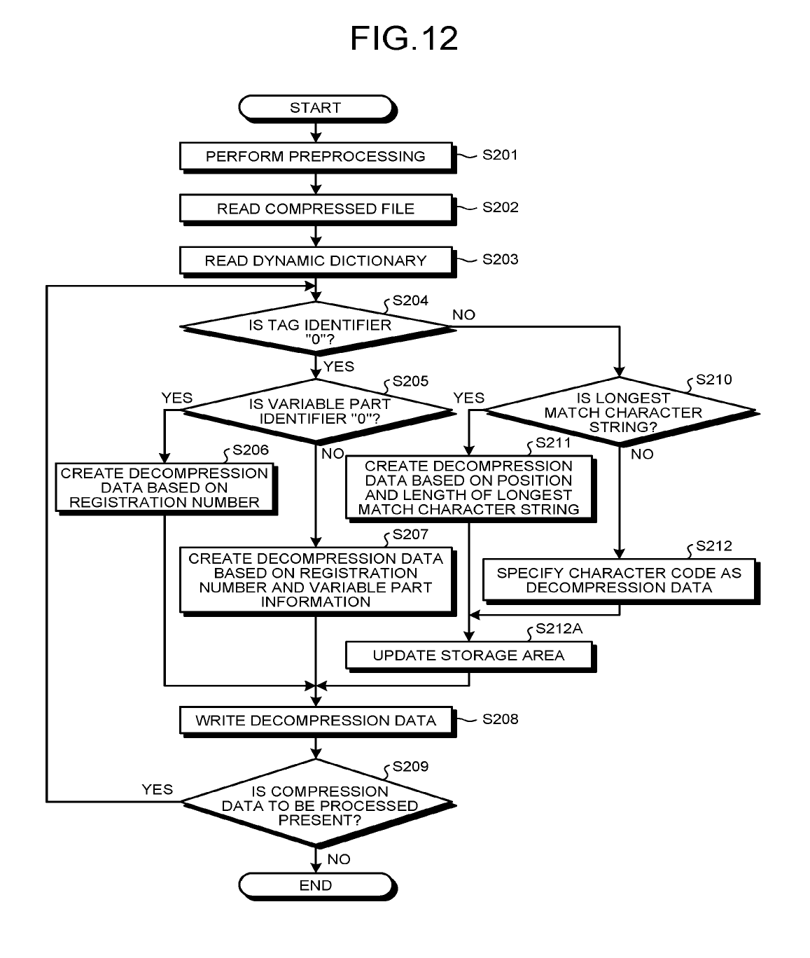

In the following, the flow of a process performed by the compression unit 100a and the decompression unit 100b illustrated in FIGS. 11 and 12 will be described.

FIG. 11 is a flowchart illustrating the flow of a process performed by the compression unit according to the embodiment. As illustrated in FIG. 11, the compression unit 100a performs preprocessing (Step S101). The preprocessing performed at Step S101, the compression unit 100a reserves the storage areas A1 to A4 in the storing unit 100c. Then, the compression unit 100a reads the character string in the file F1 targeted for compression to the storage area A1 (Step S102).

Then, the compression unit 100a extracts character strings in the storage area A1 from the top and determines whether the top of the character string is the start symbol “<” of the tag character string (Step S103).

If the top in the character string is the start symbol “<” of the tag character string (Yes at Step S103), the compression unit 100a performs a tag encoding process as follows. The compression unit 100a determines whether the tag name included in the tag character string has already been registered in the dynamic dictionary T1 (Step S104).

If the tag name included in the tag character string has not been registered in the dynamic dictionary T1 (No at Step S104), the compression unit 100a newly registers the tag character string in the dynamic dictionary T1 (Step S105). Then, the compression unit 100a outputs the compressed data that includes therein “0” as the tag identifier and the registration number that is newly registered as the compression code (Step S106). In the compressed data, “0” is set as the variable part identifier. Then, the compression unit 100a proceeds to Step S112.

In contrast, if the tag name included in the tag character string has already been registered in the dynamic dictionary T1 (Yes at Step S104), the compression unit 100a determines whether the character strings of the attribute portions exactly match (Step S107). For example, the compression unit 100a determines whether the character string of the attribute portion included in the tag character string and the character string of the subject attribute portion in the dynamic dictionary T1 exactly match.

If the character strings of the attribute portions do not exactly match (No at Step S107), the compression unit 100a determines whether the middle portions of the character strings of the attribute portions are mismatched (Step S108). If the middle portions of the character strings of the attribute portions are not mismatched (No at Step S108), the compression unit 100a proceeds to Step S105 in order to newly register the tag character string in the dynamic dictionary T1. As an example, this is a case in which the order of the attributes of the attribute portions in the character strings is replaced.

In contrast, if the middle portions of the character strings of the attribute portions are mismatched (Yes at Step S108), the compression unit 100a creates compressed data that includes therein “0” as the tag identifier and that includes therein the registration number, as the compression code, associated with the tag name that is the same as that of the tag character string (Step S109). Then, the compression unit 100a outputs the compressed data that is obtained by adding the variable part information to the created compressed data (Step S110). In the compressed data, “1” is set as the variable part identifier, whereas, in the variable part information, information on the mismatched portion is set. Then, the compression unit 100a proceeds to Step S112.

At Step S107, if the character strings of the attribute portions exactly match (Yes at Step S107), the compression unit 100a outputs the compressed data that includes therein “0” as the tag identifier and that includes therein the registration number, as the compression code, associated with the tag name that is the same as that of the tag character string (Step S111). In the compressed data, “0” is set as the variable part identifier. Then, the compression unit 100a proceeds to Step S112.

At Step S112, the compression unit 100a writes the compressed data to the storage area A4 (Step S112) and determines whether a character string to be processed is present in the storage area A1 (Step S113). If a character string to be processed is present in the storage area A1 (Yes at Step S113), the compression unit 100a proceeds to Step S103. In contrast, if a character string to be processed is not present in the storage area A1 (No at Step S113), the compression unit 100a ends the compression process.

In contrast, if the top of the character string is not the start symbol “<” of the tag character string at Step S103 (No at Step S103), the compression unit 100a performs a text encoding process of LZ77. The compression unit 100a determines whether the character string matches, as the longest match, the character string in the storage area A2 (Step S114).

If the character string matches, as the longest match, the character string in the storage area A2 (Yes at Step S114), the compression unit 100a outputs the compressed data that includes therein “1” as the tag identifier and that includes therein the position and the length of the longest match character string as the compression code (Step S115). Then, the compression unit 100a proceeds to Step S117.

In contrast, if the character string does not match, as longest match, the character string in the storage area A2 (No at Step S114), the compression unit 100a outputs the compressed data that includes therein “1” as the tag identifier and that includes therein the character code itself as the compression code (Step S116). Then, the compression unit 100a proceeds to Step S117.

At Step S117, the compression unit 100a shifts the sliding window by an amount equal to the character string encoded to the compressed data (Step S117). Namely, the compression unit 100a updates the storage area A2 by storing, in the storage area A2, the encoded character string in the storage area A1 and shifting the character string in the storage area A2 to the left by an amount equal to the encoded character string. Then, the compression unit 100a proceeds to Step S112.

FIG. 12 is a flowchart illustrating the flow of a process performed by the decompression unit according to the embodiment. As illustrated in FIG. 12, the decompression unit 100b performs preprocessing (Step S201). In the preprocessing performed at Step S201, the decompression unit 100b reserves the storage areas B1 to B4 in the storing unit 100c.

The decompression unit 100b reads the compressed file F2 (Step S202) and reads the dynamic dictionary (Step S203).

The decompression unit 100b determines whether the tag identifier of the compressed data is “0” (Step S204). If the tag identifier is “0” (Yes at Step S204), the decompression unit 100b determines whether the variable part identifier of the compressed data is “0” (Step S205).

If the variable part identifier of the compressed data is “0” (Yes at Step S205), the decompression unit 100b determines that the variable part information is not present in the compressed data and creates decompression data on the basis of the registration number (Step S206). For example, the decompression unit 100b compares the registration number included in the compressed data with the dynamic dictionary T1 in the storage area B3 and specifies the character strings of the tag name and the attribute portion associated with the registration number. The decompression unit 100b concatenates the character strings of the tag name and the attribute portion and creates decompression data. Then, the decompression unit 100b proceeds to Step S208.

In contrast, if the variable part identifier of the compressed data is not “0” (No at Step S205), the decompression unit 100b determines that the variable part information is present in the compressed data and creates decompression data on the basis of the registration number and the variable part information (Step S207). For example, the decompression unit 100b compares the registration number included in the compressed data with the dynamic dictionary T1 in the storage area B3 and specifies the character strings of the tag name and the attribute portion associated with the registration number. Then, the decompression unit 100b converts the character string of the attribute portion by using the variable part information that is included in the compressed data. Then, the decompression unit 100b concatenates the tag name and the character string that is obtained from the conversion and creates decompression data. Then, the decompression unit 100b proceeds to Step S208.

At Step S208, the decompression unit 100b writes the decompression data to the storage area B4 (Step S208).

The decompression unit 100b determines whether the compression data to be processed is present in the storage area B1 (Step S209). If the compression data to be processed is present in the storage area B1 (Yes at Step S209), the decompression unit 100b proceeds to Step S204. In contrast, if the compression data to be processed is not present in the storage area B1 (No at Step S209), the decompression unit 100b ends the decompression process.

In contrast, if the tag identifier of the compressed data is not “0” (No at Step S204), the decompression unit 100b determines whether the compression code includes therein the identifier (for example, “1”) indicating that the compressed data is based on the longest match character string (Step S210). If the compression code includes therein the identifier indicating that the compressed data is based on the longest match character string (Yes at Step S210), the decompression unit 100b creates decompression data on the basis of the position and the length of the longest match character string (Step S211). For example, the decompression unit 100b specifies the position and the length of the longest match character string included in the compression code. Then, the decompression unit 100b reads the character string associated with the position and the length from the storage area B2 and creates the read character string as decompression data. Then, the decompression unit 100b proceeds to Step S212A.

In contrast, of the compression code includes therein the identifier indicating that the compressed data is not based on the longest match character string (No at Step S210), the decompression unit 100b specifies the character code as the decompression data (Step S212). For example, the decompression unit 100b specifies the character code itself that is included in the compression code as the decompression data. Then, the decompression unit 100b proceeds to Step S212A.

At Step S212A, the decompression unit 100b updates the storage area B2 (Step S212A). For example, the decompression unit 100b deletes the decompressed compressed data from the storage area B1, shifts the storage area B2 to the left by an amount equal to the character string of the decompression data, and writes the decompression data to the storage area B2. Then, the decompression unit 100b proceeds to Step S208.

In the following, an advantage of the information processing apparatus 100 according to the embodiment will be described. The information processing apparatus 100 inputs a character string data that includes therein a tag. When the information processing apparatus 100 performs the compression process using a sliding window on the input character string data, the information processing apparatus 100 determines whether the character string targeted for the compression process is a tag. If the character string targeted for the compression process does not include a tag, the information processing apparatus 100 performs the compression process that uses a sliding window with respect to the character string targeted for the compression process and moves the character string targeted for the compression process to the area of the sliding window. If the character string targeted for the compression process includes a tag, the information processing apparatus 100 performs, on the subject tag, a compression process that is different from the compression process that uses the sliding window. With this configuration, if the character string targeted for the compression process includes a tag, because the information processing apparatus 100 performs the compression process that is different from the compression process that uses the sliding window, it is possible to improve a compression ratio of a character string that does not include a tag and that is a processing target of the compression process that uses a sliding window.

Furthermore, with the information processing apparatus 100 according to the embodiment, when the information processing apparatus 100 performs the different compression process, the information processing apparatus 100 further moves the character string of the tag to the tag area that is different from the area of the sliding window. With this configuration, because the information processing apparatus 100 does not move the character string of the tag to the area of the sliding window, it is possible to improve a compression ratio of the character string that does not include a tag.

Furthermore, with the information processing apparatus 100 according to the embodiment, when the information processing apparatus 100 performs another compression process, the information processing apparatus 100 collectively associates the content of the entirety of the tag with a single registration number, registers the association relationship in the dynamic dictionary T1, and compresses the character string targeted for compression to the information based on the registration number. With this configuration, the information processing apparatus 100 registers the content of the entirety of the tag in the dynamic dictionary T1 by associating the content with a single registration number and compresses the entirety of the tag to information based on the single registration number. Consequently, the information processing apparatus 100 can prevent the entirety of the single tag from being divided into pieces and allocated to a plurality of compression codes and thus can improve a compression ratio. Namely, the information processing apparatus 100 can prevent the entirety of the tag from parting in tears.

Furthermore, with the information processing apparatus 100 according to the embodiment, when the information processing apparatus 100 performs another compression process, the information processing apparatus 100 determines whether the content of a tag exactly matches the content of the tag stored in the dynamic dictionary T1. If the both exactly match, the information processing apparatus 100 compresses the character string targeted for the compression to the registration number that is associated with the content of the exactly matched tag. With this configuration, because the information processing apparatus 100 compresses the character string targeted for the compression to the already registered registration number, a compression ratio can be improved and a compression speed can also be improved.

Furthermore, with the information processing apparatus 100 according to the embodiment, when a match is not an exactly match, if the name of a tag in the content of the tag matches and the contents other than the name of the tag partly match, the information processing apparatus 100 compresses the character string targeted for the compression with respect to the information in which the content of the mismatched portion is added to the registration number that is associated with the content of the tag. With this configuration, the information processing apparatus 100 can improve a compression ratio when compared with a case in which a longest match character string search is performed related to a tag. Furthermore, the information processing apparatus 100 can reduce the storage capacity needed for the dynamic dictionary T1.

In the following, the ability to improve a compression ratio will be described with reference to the third column illustrated in FIG. 5. If the tag character string in the storage area A1 is “<a href=“0002.html”>”, for the content of the tag stored in the dynamic dictionary T1, the portion of “1” indicated by a code z1 and the portion of “02” indicated by a code z2 are mismatched. If a longest match character string search is performed, a first half portion and a second half portion become the longest match character strings and the middle portion, which is a mismatched portion, does not become the longest match character string. The size of compressed data used for the longest match character string search is about 8 bytes that are the sum of 3 bytes that indicate the position and the length in the first half portion, 3 bytes that indicate the position and the length in the second half portion, and 2 bytes that indicate the number of mismatched characters in the mismatched portion in the middle portion. In contrast, the size of compressed data according to the embodiment is about 7 bytes that are the sum of 2 bytes that indicate the registration number, 1 byte that indicates the variable part starting position as the variable part information, 1 byte that indicates the length of the variable part, 1 byte that indicates the length of the replacement character string, and 2 bytes that indicate the replacement character string. Accordingly, the size of the compressed data according to the embodiment is smaller than the size of the compressed data that is used when a longest match character string search is performed. Consequently, the information processing apparatus 100 can improve a compression ratio when compared with a case of performing the longest match character string search.

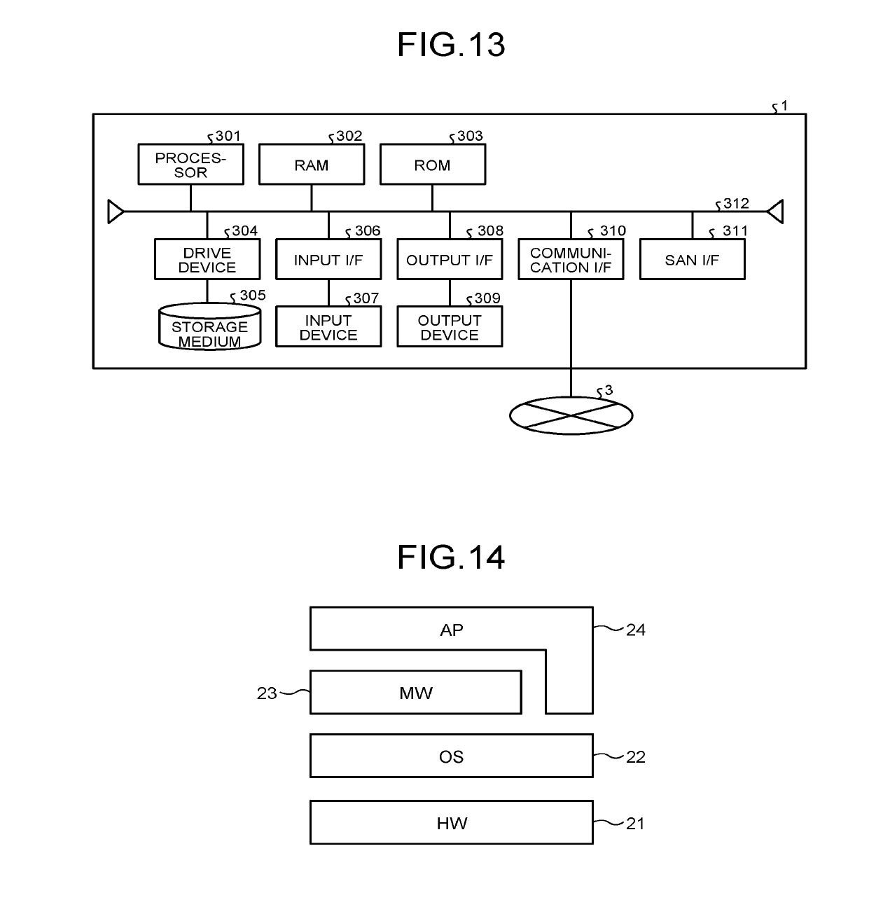

In the following, hardware and software that are used in the embodiment will be described. FIG. 13 is a block diagram illustrating an example of the hardware configuration of a computer 1. The computer 1 includes, for example, a processor 301, a random access memory (RAM) 302, a read only memory (ROM) 303, a drive device 304, a storage medium 305, an input interface (I/F) 306, an input device 307, an output interface (I/F) 308, an output device 309, a communication interface (I/F) 310, a storage area network (SAN) interface (I/F) 311, a bus 312, and the like. The hardware is connected via the bus 312 each other.

The RAM 302 is a memory device that allows data items to be read and written. For example, a semiconductor memory, such as a static RAM (SRAM), a dynamic RAM (DRAM), or the like, is used or, instead of a RAM, a flash memory or the like is used. The ROM 303 also includes a programmable ROM (PROM) or the like. The drive device 304 is a device that performs at least one of the reading and writing of information recorded in the storage medium 305. The storage medium 305 stores therein information that is written by the drive device 304. The storage medium 305 is, for example, a flash memory, such as a hard disk, a solid state drive (SSD), or the like, or a storage medium, such as a compact disc (CD), a digital versatile disc (DVD), a blue-ray disk, or the like. Furthermore, for example, regarding the plurality types of storage media, the computer 1 provides the drive device 304 and the storage medium 305.

The input interface 306 is a circuit that is connected to the input device 307 that sends an input signal received from the input device 307 to the processor 301. The output interface 308 is a circuit that is connected to the output device 309 and that allows the output device 309 to perform an output in accordance with an instruction from the processor 301. The communication interface 310 is a circuit that controls communication via the network 3. The communication interface 310 is, for example, a network interface card (NIC) or the like. The SAN interface 311 is a circuit that control communication with a storage device connected to the computer 1 via the storage area network. The SAN interface 311 is, for example, a host bus adapter (HBA) or the like.

The input device 307 is a device that sends an input signal in accordance with an operation. The input device 307 is, for example, a keyboard; a key device, such as buttons attached to the main body of the computer 1; or a pointing device, such as a mouse, a touch panel, or the like. The output device 309 is a device that outputs information in accordance with control performed by the computer 1. The output device 309 is, for example, an image output device (display device), such as a display or the like, or an audio output device, such as a speaker or the like. Furthermore, for example, an input-output device, such as a touch screen or the like, is used as the input device 307 and the output device 309. Furthermore, the input device 307 and the output device 309 may also be integrated with the computer 1 or may also be devices that are not included in the computer 1 and that are, for example, connected to the computer 1 from outside.

For example, the processor 301 reads a program stored in the ROM 303 or the storage medium 305 to the RAM 302 and performs, in accordance with the procedure of the read program, the process of the compression unit 100a or the process of the decompression unit 100b. At that time, the RAM 302 is used as a work area of the processor 301. The function of the storing unit 100c is implemented by the ROM 303 and the storage medium 305 storing program files (an application program 24, middleware 23, an OS 22, or the like, which will be described later) or data files (the file F1 targeted for compression, the compressed file F2, or the like) and by using the RAM 302 as the work area of the processor 301. The program read by the processor 301 will be described with reference to FIG. 14.

FIG. 14 is a schematic diagram illustrating a configuration example of a program running on the computer 1. In the computer 1, the operating system (OS) 22 that controls a hardware group 21 (301 to 312) illustrated in FIG. 13 operates. The processor 301 operates in accordance with the procedure of the OS 22 and then the control and management of the hardware group 21 is performed, whereby the processes in accordance with the application program 24 or the middleware 23 are performed in the hardware group 21. Furthermore, in the computer 1, the middleware 23 or the application program 24 is read into the RAM 302 and is executed by the processor 301.

If a compression function is called, the processor 301 performs processes based on at least a part of the middleware 23 or the application program 24, whereby the function of the compression unit 100a is implemented (by the processor 301 performing the processes by controlling the hardware group 21 on the basis of the OS 22). Furthermore, if the compression function is called, the processor 301 performs processes based on at least a part of the middleware 23 or the application program 24, whereby the function of the decompression unit 100b is implemented (by the processor 301 performing the processes by controlling the hardware group 21 on the basis of the OS 22). The compression function and the decompression function may also be included in the application program 24 itself or may be a part of the middleware 23 that is executed by being called in accordance with the application program 24.

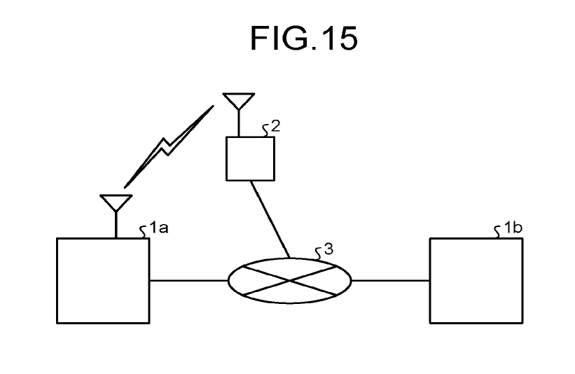

FIG. 15 is a schematic diagram illustrating a configuration example of a device in a system according to the embodiment. The system illustrated in FIG. 15 includes a computer 1a, a computer 1b, a base station 2, and a network 3. The computer 1a is connected to the network 3 that is connected to the computer 1b by using wireless or wired connection.

The compression unit 100a and the decompression unit 100b illustrated in FIG. 8 may also be included in either the computer 1a or the computer 1b illustrated in FIG. 15. The computer 1b may also include the compression unit 100a, whereas the computer 1a may also include the decompression unit 100b. Alternatively, the computer 1b may also include the compression unit 100a, whereas the computer 1a may also include the decompression unit 100b. Furthermore, both the computer 1a and the computer 1b may also include the compression unit 100a and the decompression unit 100b.

In the following, a part of a modification of the above described embodiment will be described. In addition to the modification described below, design changes can be appropriately made without departing from the scope of the present invention. The target for the compression process may also be, in addition to data in a file, monitoring messages that are output from a system. For example, a process that compresses the monitoring messages that are sequentially stored in a buffer by using the compression process described above and that stores the compressed messages as log files is performed. Furthermore, for example, the compression may also be performed for each page in a database or may also be performed in units of multiple pages.

Furthermore, in the embodiment, the tag is the character string that begins with the start symbol “<” and that ends with the end symbol “>”; however, the embodiment is not limited thereto and a symbol having the same role as the tag in a structured document may also be used.

According to an embodiment of the present invention, an advantage is provided in that a compression ratio can be improved in a compression process performed on a structured document in which a tag or the like is included in a text.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A computer-readable recording medium having stored therein a conversion program using a sliding window that causes a computer to execute a process comprising:
judging whether a target character string includes a tag, the target character string being targeted for a first conversion process using the sliding window and being part of input character string data;
performing the first conversion process on the target character string and moving the target character string to the sliding window when the target character string does not include any tags; and
performing a second conversion process on the tag, when the target character string includes the tag, the second conversion process being different from the first conversion process.

2. The computer-readable recording medium according to claim 1, wherein the performing the second conversion process further includes moving the tag to a tag area that is different from the sliding window.

3. The computer-readable recording medium according to claim 1, wherein the performing the second conversion process further includes registering, in association with a single registration number, the character string of the tag as a set in a dictionary and converting the character string of the tag to information based on the registration number.

4. The computer-readable recording medium according to claim 3, wherein the performing the second conversion process further includes determining whether the character string of the tag exactly matches the character string of the tag stored in the dictionary and converting, when the both character strings exactly match, the character string of the tag to the registration number being associated with the exactly matched character string of the tag.

5. The computer-readable recording medium according to claim 4, wherein, when the both character strings do not exactly match, the performing the second conversion process further includes converting, when, in the character string of the tag, a character string associated with the name of the tag matches and a character string other than the name of the tag partly matches, the character string of the tag to information in which a character string of a mismatched portion is added to the registration number being associated with the character string of the tag.

6. The computer-readable recording medium according to claim 1, wherein the tag includes therein a symbol for identifying a tag, a character string indicating an attribute of a tag, and variable part information being associated with the character string indicating the attribute of the tag.

7. An information processing apparatus comprising:
an input unit that inputs a character string data that includes therein a tag;
a determining unit that judges whether a target character string includes a tag, the target character string being targeted for a first conversion process using the sliding window and being part of input character string data;
a first conversion processing unit that performs the first conversion process on the target character string and that moves the target character string to the sliding window when the target character string does not include any tags; and
a second conversion processing unit that performs, when the determining unit judges that the target character string includes the tag, the second conversion process being different from the first conversion process.

8. A conversion process method comprising:
judging whether a target character string includes a tag, the target character string being targeted for a first conversion process using a sliding window and being part of input character string data;
performing the first conversion process on the target character string and moving the target character string to the sliding window when the target character string does not include any tags; and
performing a second conversion process on the tag, performed by the computer when the target character string includes the tag, the second conversion process being different from the first conversion process.
